(19) United States
(12) Patent Application Publication
(10) Pub. No.: US 2025/0234104 A1
(43) Pub. Date: Jul. 17, 2025

(54) IMAGE PROCESSING ARRANGEMENTS, INCLUDING METHODS FOR DYNAMIC RANGE EXTENSION AND NOISE REDUCTION

(71) Applicant: Transformative Optics Corporation, Portland, OR (US)

(72) Inventor: Geoffrey B. Rhoads, West Linn, OR (US)

(21) Appl. No.: 19/013,418

(22) Filed: Jan. 8, 2025

Related U.S. Application Data
(60) Provisional application No. 63/621,986, filed on Jan. 17, 2024.

(51) Int. Cl. H04N 25/585; H04N 23/72; H04N 23/73; H04N 23/74; H04N 23/741; H04N 23/76; H04N 25/51; H04N 25/671

(52) U.S. Cl. CPC H04N 25/585; H04N 23/72; H04N 23/73; H04N 23/74; H04N 23/741; H04N 23/76; H04N 25/51; H04N 25/671

(57) ABSTRACT

High dynamic range (HDR) imaging, and so-called ‘denoising’ of CMOS-sensor-derived image data, are a universally pursued and evolving technical art. This disclosure further advances the art, honing in on the measurable non-uniformities of CMOS sensors as one of the major challenges to increasing dynamic range and decreasing noise. Simplicity and low cost of mass-scale deployment of these approaches become a central commercial requirement. Provisions are described for measuring sensor non-uniformities, generating efficient informational storage of these non-uniformities, then using this stored information during operation of a sensor in a wide variety of camera applications. Extensions of dynamic range on the order of 2 to 4 bits per pixel are typical.

### RELATED APPLICATION DATA

This application claims priority from provisional application 63/621,986, filed Jan. 17, 2024.

This application expands on the disclosures of U.S. application Ser. No. 18/056,704, filed Nov. 17, 2022 (now U.S. Pat. No. 12,047,692), and international application PCT/US23/73352, filed Sep. 1, 2023 (now published as WO2024147826).

The technology detailed below can advantageously be included in implementations of the arrangements detailed in provisional applications 63/659,125, filed Jun. 12, 2024, and 63/740,985, filed Dec. 31, 2024.

The above-identified documents are incorporated by reference, as if fully set forth herein.

### TECHNICAL FIELD

In certain aspects, the present technology concerns signal processing to improve digital imagery captured by a camera.

### INTRODUCTION

While Moore's Law has seen tremendous advances in other areas of computing, improvements in digital imaging have not kept up. Digital imaging systems have persistently suffered from a variety of shortcomings, including limited bit-depth (poor dynamic range) and noise from various sources. The present technology addresses certain of these longstanding shortcomings.

In a first phase of operation, a camera (photosensor array) is employed to generate sensor characterization (calibration) data. Our earlier patent filings use the term Chromabath for this phase of operation. Representation of the resultant sensor characterization data can take the form of pixel byte codes, which serve as standardized expressions of such information across different instances and varieties of image sensors.

In a second phase of operation, during normal camera service, the sensor characterization data is employed to enhance the bit-wise dynamic range and/or noise performance of sensor pixels, assisting in such applications as low light imagery or low-contrast scenes. We sometimes use the term ShadowChrome to refer to such processing. In particularly-described embodiments, we assume the sensor pixels are overlaid with a Bayer color filter array, although this is not essential.

One embodiment includes a method to characterize the pixel response behavior of an image sensor having an array of multiple pixels. The array includes a first pixel overlaid with a color filter of a first color and a second pixel overlaid with a color filter of a second color different than the first color. The second pixel edge- or corner-adjoins the first pixel.

Such method includes capturing plural sets (e.g., frames) of pixel signals, including sets of pixel signals captured under differing achromatic illumination conditions. For each set, a brightness metric associated with the first pixel is computed. This computation is based on signal values for a subset of pixels that includes the first pixel, and also may include the adjoining second pixel (with its different color filter). From the resulting brightness metrics, together with signal values of the first pixel in the captured sets of pixel signals, pixel characterization data is determined that serves to characterize, or establish, a statistical mid-point value for a signal expected from the first pixel, as a function of the brightness metric. For example, the characterization data can comprise slope and offset coefficients of a linear equation by which an expected mid-point value for the first pixel can be computed from an associated brightness metric.

Another embodiment includes a method to refine pixel signal values produced by such an image sensor. Such method includes using the sensor to capture (produce) pixel signals depicting a scene. From these pixel values, a scene brightness metric is determined for a neighborhood of pixels associated with a first pixel. This neighborhood may include pixels having color filters of differing colors, where a majority of pixels in the neighborhood are located at a distance of less than 64 pixel rows and 64 pixel columns from the first pixel. This brightness metric is then used, in conjunction with pixel characterization data recalled from a memory, to establish a statistical mid-point value for a signal expected from the first pixel. The expected value for the first pixel is then compared with the actual value for the first pixel in the captured scene data. Based at least in part on a result of this comparison, a refined, transformed signal value for said first pixel is determined. In some embodiments, this refined signal value has a greater bit depth than the captured pixel signal. For example, if the sensor produces N-bit (e.g., 8-bit) pixel data, the refined signal value for the first pixel may be (N+P) bits, where P>1 (e.g., the refined signal value may be 12-bits). The signal-to-noise ratio of the captured image can thereby be improved, commonly by a factor of at least 2\hat{ }(P-2) or 2\hat{ }(P-1).

It should be emphasized that the present specification builds on the disclosures of applicant's earlier, cited patent documents. These documents should be read as a composite whole, with the earlier-described arrangements being understood as particular environments in which the presently-described arrangements can be practiced.

### BRIEF DESCRIPTION OF THE DRAWINGS

FIG. 1 is a histogram of pixel data output by a single pixel under fixed illumination conditions, and identifies the statistically-expected mid-point value.

FIG. 1A is similar to FIG. 1, but shows histograms of pixel data output by the single pixel under several different fixed illumination conditions, and the statistically-expected mid-point value (median) of each.

FIG. 2 illustrates how a curve can be fit to the statistically-expected mid-point values at different illumination conditions, to thereby enable estimation of such mid-point values at other illumination conditions.

FIG. 3 shows how pixels of an image sensor can be grouped into abscissa blocks.

FIG. 4 is a flow chart of one aspect of the present technology.

FIG. 5 shows that abscissa groupings can be tailored to correspond to image or video objects, such as faces.

FIGS. 6, 7, 7A, 8 and 9 illustrate various sigmoid-like transformation functions in accordance with certain aspects of the present technology.

FIG. 10 is a block diagram of one particular embodiment.

### DETAILED DESCRIPTION

### Gathering Characterization Data

The first, sensor characterization, phase in an illustrative embodiment commonly starts by capturing a large number of frames—hundreds or thousands—with the sensor blocked from light, as by a lens cap. A histogram of integer output values for each pixel can thereby be determined.

Most of the pixels have histograms that exhibit a generally Gaussian shape. However, a few percent of the sensor pixels typically have what may be termed rogue distributions, evidencing asymmetry, or humps away from the center. (We consider a rogue distribution to be a histogram in which more than 1% of the pixel values are four, five, six or more standard deviations from the mean.) Regardless of such aberrations, the measured histogram data for each pixel is processed to determine a center value. While the average or centroid of the sampled pixel values can be used, applicant prefers to use the fractional median value of the histogram as the center value. Such approach is believed preferable in the real-world circumstances of histograms that aren't strictly Gaussian. The array of center values thereby determined may be regarded as dark frame data for the sensor.

For an illustrative Sony IMX477 sensor (4056×3040 pixels, or 12 MP), in 12-bit mode, most pixels—regardless of associated Bayer filter color—are found to have nominal dark frame values of about 256 DN (digital numbers). The RMS spread of the samples around the center of the histogram is typically in the range of 1-2 DN. This RMS value is an indication of the pixel's noise under dark conditions. (The standard deviation of the histogram is an alternative indication of the pixel's noise. Unless otherwise noted, we use the RMS value to quantify pixel noise.)

The center value for each pixel's histogram, e.g., in floating-point form (not integer), is stored in a memory for later use. In some embodiments, the dark frame noise value for each pixel is also stored in the memory.

A pixel's dark frame value is due to thermal (dark current) noise, shot noise, read noise (due to electronics of the sensor when charge stored within a pixel is read-out), and pixel-to-pixel manufacturing variations in the physical attributes of each pixel and associated electronic circuitry (sometimes termed fixed pattern noise). However, the larger part of a pixel's dark frame value (such as the values around 256 in the case of the IMX477) is typically due to a pixel bias value. A bias value is deliberately implemented in the sensor circuitry to assure that each pixel's output value is never below zero when the pixel's accumulated charge is sampled and converted into a digital number by an A/D converter-despite all of the just-mentioned noise sources. (A few sensors disregard this consideration and produce dark frame pixel values of zero. So-doing also masks the thermal and other noise in the pixel's output signal. Such sensors are ill-suited for use in most of the presently-described embodiments, since statistical behavior of such noise-like signals is used to discriminate tones and colors at very low signal-to-noise ratios.)

In the prior art, the bias value used by a sensor is commonly subtracted from the sensor's raw pixel values to yield bias-compensated pixel values. (The bias-compensated pixel values may be scaled up fractionally to account for the reduction in values caused by bias compensation.) Relatedly, in specialized image sensors used for astrophotography, measured dark frame pixel values are sometimes subtracted from raw pixel values to account for dark frame variations.

One problem with the foregoing arrangements is that such correction techniques are typically integer-based. Thus, only rarely is a pixel's value accurately corrected. More often, there is a fractional-value error in the corrected value. This may be termed digitization noise.

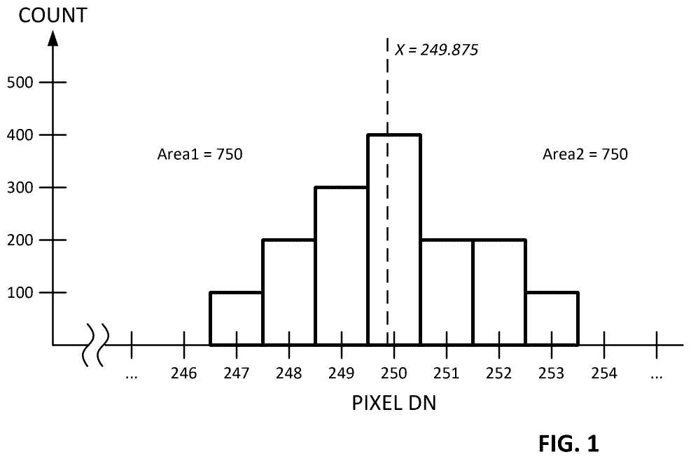

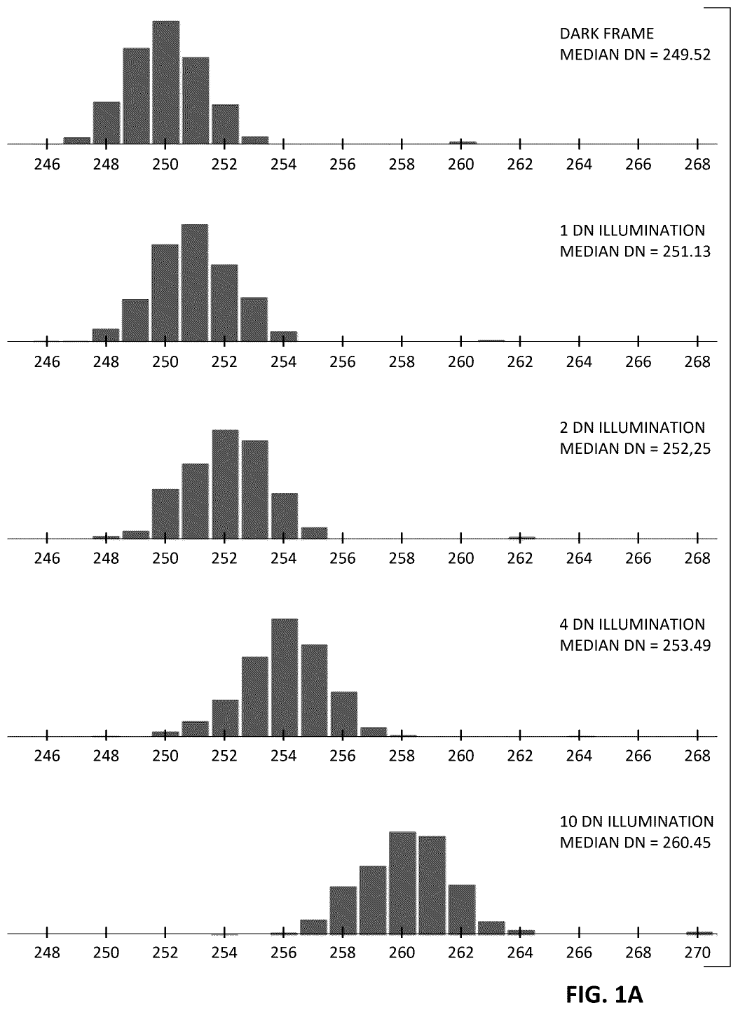

As noted, one embodiment desirably employs the fractional median value of a pixel's measured histogram to determine its statistical center point (mid-point) under dark conditions. Conceptually, such a value is determined by treating the pixel's histogram plot as a 2D area. The desired real-valued median is then determined by the x-coordinate location of a vertical line that divides the histogram into two equal-area halves. FIG. 1 illustrates, with the vertical line placed so that Area1=Area2.

A next aspect of calibration performs measurements akin to the dark-frame operations just discussed, but under dim illumination with substantially-white light. This operation may be repeated several times, at several different dim illumination levels.

“Substantially white” here means light having an intensity that varies less than 5%, and preferably less than 3% or 2% (and ideally less than 1% or 0.5%), across the spectrum of interest, e.g., the visible light spectrum of 400 to 700 nm, or the IR-extended light spectrum of 400 to 1000 nm, or the UV- and IR-extended light spectrum of 200 to 1000 nm. “Dim” illumination here means illumination at a level that produces a signal-to-noise ratio of 10 or less in the raw pixel data from the photosensor (which often corresponds to pixel values on the order of 10 or 20 digital numbers above their dark state values). We sometimes use the term “dim grey illumination” or “dim achromatic illumination” to refer to dim illumination with substantially white light.

In bright scenes, a sensor's signal-to-noise ratio is dominated by shot noise, which is proportional to the square root of the illumination (following a Poisson distribution). At dim illuminations, however, the combined effects of dark current noise, read noise, fixed pattern noise, color filter characteristics, and other systemic anomalies become significant.

In one arrangement, the image sensor is pointed to a white wall and defocused. The imaging exposure conditions are chosen so that when averaged over hundreds or thousands of captured image frames, the average raw output value across all sensor pixels is about 1 DN higher than the sensor's average raw output pixel value with no illumination (dark conditions, sometimes termed “dark state”). Such dim exposure conditions can be achieved, e.g., by varying the intensity of the light source that illuminates the wall, by varying the camera aperture size, or by varying the length of the exposure. (The length of the exposure is varied in an illustrative embodiment.) Again, a histogram of raw integer values is collected for each individual pixel, and a real-valued center point of each histogram is determined and stored, as described above. A noise value for each pixel can also be determined and stored.

The exposure conditions may then be changed so that the pixels' average output value is about 2 DN over the average dark condition value, and the above process is repeated. And similarly at 4 DN and 10 DN. Thus, in this particular arrangement, histogram data are gathered at four different dim grey illumination conditions, and the center of each histogram is determined. Again, a noise value for each pixel can be determined, at each different illumination level.

A greater or smaller number of illumination levels can be used. These may be distributed at logarithmic intervals, extending, e.g., from 1 DN up to about ten times the average RMS noise value for the sensor's pixels.

(Sensor pixel values are sometimes expressed as counts of photoelectrons, particularly in specification of sensor noise. Different cameras relate photoelectron count to digital number by different ratios. Some 14-bit astronomical cameras increase the digital number by about 3.5 for each photoelectron. Many 8-bit consumer cameras have a nearly-inverse ratio, increasing the digital number by about 1 for every three photoelectrons. If camera noise is specified in terms of photoelectron count, then the different dim lighting levels can similarly be selected in terms of photoelectron count. Most contemporary cameras have pixel noise of less than 10 photoelectrons, with noise of 3 to 5 photoelectrons being illustrative.)

FIG. 1A shows exemplary histograms sampled from a single pixel under different illumination conditions (dark, and dim grey lighting at levels of 1, 2, 4 and 10 DN above dark). The medians rise with increasing illumination, but not always linearly-so as theory might suggest. Each of these depicted histograms has a rogue character—with a small hump of values that consistently appears well above the bulk of the histogram at each level (such as the small count of “262” values in the histogram for 2 DN).

At each of the dim grey illumination levels, the real-valued median value (i.e., the histogram center point) for each pixel can be compared to median values across the sensor. There will be variations. Some variations are small (e.g., low single percent or less) and are due to factors such as manufacturing imperfections. Other variations are large (e.g., tens of percent) and may be due to factors such as lens vignetting, which causes the periphery of an image to be darker than the center. Still other large variations are found between pixels of different colors. For example, green pixels respond more quickly (strongly) to increases in illumination than red and blue pixels.

In a particular example, the sensor-wide average center value at a given illumination level is assigned a gain of 1.0, and all other pixel gains are specified relative to that average value. In another example, the pixel having the sensor-wide peak center value at a given dim grey illumination level is assigned a gain of 1.0, and all other pixel gains are specified relative to that peak value. Such “grey gain” data will later be applied to raw pixel values to compensate for gain variations. Such operation also serves to convert the integer pixel values into real (floating point) values.

In variant implementations, histograms are collected at dim grey illumination levels chosen to yield average pixel noise levels that are multiples of the dark frame RMS noise value, rather than DN offsets (1, 2, 4 and 10) from it. That is, dim grey histograms are collected at different target signal-to-noise ratios. One particular implementation may vary the dim light exposure interval so as to collect pixel histogram data at signal-to-noise ratios of 1, 2, 4 and 8.

In a particular implementation, the camera captures 1250 calibration frames: 250 dark frames, and 250 frames in each of four dim illumination conditions. From this data set, five histograms are computed for each sensor pixel: one under the dark conditions, and one under each of the four dim illumination conditions (e.g., as in FIG. 1A). The center value for each histogram is determined, yielding five center values for each pixel-one at each illumination condition. For each pixel, a curve is fit to these five sample values, so that a statistically-expected mid-point value can be determined for the pixel at any illumination condition between dark, and the illumination used to capture the brightest calibration frames. In an illustrative implementation, parameters defining the curve are adjusted to determine a least-squares best fit. That is, parameters are chosen to minimize the sum of the five error terms, between the five sample values and corresponding curve values, each squared. (In other implementations, other curve fitting distance measures can be employed, such as based on a sum of errors themselves, or a sum of errors each raised to the p-th power.) In a simple implementation, the curve is first order, with a linear gain (scale) term and a real number offset. In other embodiments, curves of other types can be used (e.g., a polynomial equation having three or more terms instead of just two).

(While full frames are captured in the illustrative embodiment, it will be recognized that this is not necessary; the same principles can be applied to sets of pixel data captured otherwise, such as by spatial regions of interest.)

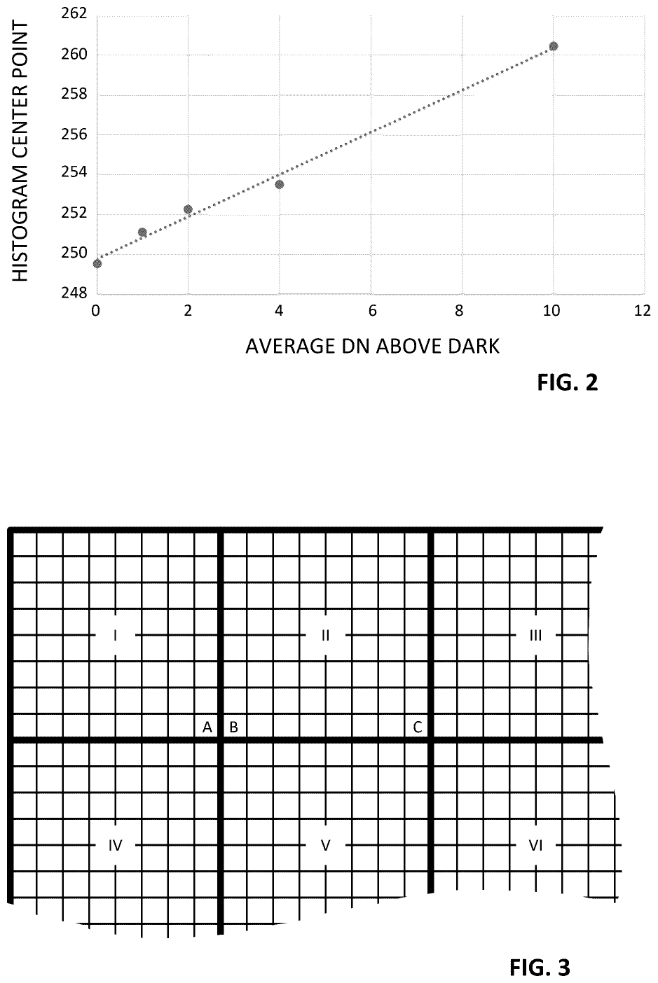

FIG. 2 illustrates an exemplary curve-fitting arrangement for one pixel. Five points are plotted, corresponding to the center points of the five histograms in FIG. 1A. A linear curve is least-squares fit to this set of data points. The equation of this particular curve is:

1.0575DN+249.77

This curve fitting operation determines 1.0575 is the grey gain for this pixel; 249.77 is the offset. From these two parameters, we can estimate the expected center-point value for this particular pixel at any dim level of brightness. Each pixel in the image sensor is similarly characterized by respective parameters.

The five illumination conditions were set on a sensor-wide basis, e.g., aiming for an increase in average, sensor-wide, pixel output signals of 1, 2, 4 and 10 DN over dark values. But the illumination may have not been perfectly uniform across the sensor. Moreover, characteristics of pixels tend to vary with a pixel's position within the pixel array. Accordingly, rather than fit a curve to a pixel's five center values as a function of global sensor illumination, it is preferable to define such a curve as a function of local illumination. (That is, local illumination defines the abscissa of the curve.)

A particular implementation divides each of the calibration frames into 8×8 pixel groupings, or abscissa blocks, starting in the upper left corner of the image frame. A portion of such a frame is shown in FIG. 3, with several groupings outlined in bold. These groupings are identified by roman numerals I, II, III, IV, V and VI. The 12 MP Sony IMX477 sensor includes 192,660 such groupings. Each grouping spans a 4×4 area of Bayer filter cells (each Bayer cell being a 2×2 pixel pattern) and comprises 64 pixels. A brightness metric is derived for each.

Although an endless variety of different brightness metrics may be devised, for purposes of illustration we employ a simple sum of the 64 raw pixel values. Alternatively, a sum of bias-compensated pixel values can be used, e.g., raw values each adjusted by subtracting a sensor-wide mean of the bias values (offsets). This sum includes values from differently-filtered pixels, i.e., 32 green pixel values, 16 red pixel values, and 16 blue pixel values. This sum may be termed the “abscissa” value for the grouping, and serves as a brightness metric that is associated with each of the 64 pixels within the region. So, for any given frame, a pixel has an associated abscissa value, which here is the sum of 64 pixel values in the 8×8 grouping of which the pixel is a member.

One variant brightness metric disregards the value(s) of pixels having the J largest raw output values when computing the sum, where J is less than 5% or 10% of the count of pixels in the abscissa block. Other variant metrics use the median or mean of the 64 pixel values as the abscissa value, rather than their sum. Still another variant metric sums the pixel values each raised to the Kth power, where K is a value (often non-integer) greater than 1 and less than 3, possibly disregarding the J largest raw output values. Still other variant brightness metrics disregard the values of any pixels in the group that are deemed too noisy to be useful (e.g., dead pixels), and apply a corresponding scale factor to compensate for the missing pixel value(s). Some brightness metrics reduce the measure to a per-pixel figure, making the abscissa value independent of the size of the abscissa group. The mean and median cases are simple examples of such approach.

Groupings of different sizes and shapes can be used for abscissa pixel groupings. A very simple grouping comprises just five pixels—the subject pixel, and the pixels immediately-adjoining to the north, south, east and west in the photosensor array. However, this can yield blocks with pixels of just two-different colors when employed with Bayer-pattern photosensors (i.e., when the subject pixel is blue or red, then the other four pixels are all green). More commonly, groups larger than five pixels are used, and all filter colors are represented. Another small group, but including the red, green and blue filter colors in a Bayer pattern, comprises the subject pixel (e.g., red-filtered), together with its four edge-adjoining pixels (green-filtered) and its four corner-adjoining pixels (blue-filtered), nine in all.

While the abscissa blocks shown in FIG. 2 do not overlap, this is not essential. In other embodiments, overlapping abscissa groupings can be employed.

Typically, the groups of pixels from which the abscissa values are determined are subsets comprising less than 1%, and often less than 0.005% or 0.001%, of all pixels in the photosensor array. In the example given, there are 192,660 8×8 pixel blocks in the IMX477 photosensor, so each block comprises a subset of about 0.00052% of the total sensor pixel count. In another illustrative embodiment, the abscissa groupings comprise blocks of 16×16 pixels, of which there are 48,165 across the IMX477 sensor, so each spans 0.0021% of the photosensor area. (We sometimes term such groupings “proper” subsets of all pixels in the photosensor array, since each includes less than all pixels in the array.) Commonly, most or all of the pixels in the abscissa subset are in a spatial neighborhood within 64 rows and 64 columns of the subject pixel, and mostly commonly a majority of the pixels in the abscissa subset are in a spatial neighborhood within 16 rows and 16 columns (or 8 rows and 8 columns) of the subject pixel.

In some embodiments, the abscissa group of pixels spans several image frames of data, e.g., including an 8×8 spatial group of pixels found in the current frame, and found at the same location in one or more preceding and/or following frames in a series.

Returning to the curve fitting, for each of the illustrative 1250 calibration frames, local abscissa values are determined from pixel values for each 8×8 pixel grouping. For example, when 250 calibration frames are collected with sensor-wide illumination at 1 DN over dark conditions, the 64 values in each grouping are summed for each frame, and averaged across the 250 calibration frames. This yields, for each of the 8×8 pixel groupings, an averaged local brightness value indicating the illumination conditions under which the histogram data for pixels in that grouping was collected. 192,660 such abscissa values are computed for each of the 250 calibration frames captured in 1-DN-over-dark-conditions, and likewise for each of the other four calibration conditions (including the dark condition). For a given pixel, a curve is defined to fit its five center point values (associated with the five different illumination conditions used in calibration) to five associated abscissa values. For each pixel, parameters defining such curve are stored for later use. As noted, in a simple embodiment, the curve is first order and is characterized by gain and offset parameters. From such data we can precisely estimate a given pixel's expected center-point value, for any dim grey illumination condition (indicated by a brightness metric).

In such implementation, the curve-fitting illustrated in FIG. 2, in which the horizontal axis indicates a digital number value above dark conditions, can be implemented instead with the horizontal axis indicating the local brightness metric (abscissa value). Moreover, instead of separately finding the center-point of the 250-pixel value histogram for each of five different illumination conditions, and then determining the center point of each histogram, and then fitting a linear curve to these five center points, a linear fit can instead be determined by fitting a linear curve to the 1250 {Raw, Abscissa} value pairs, yielding offset and gain calibration values for that pixel.

Another embodiment does not collect multiple sets of dim grey image frames. Instead, a single set of 250 dim grey image frames is collected, at a single illumination level. (Again, the camera can be pointed to a dimly-illuminated white wall, and collect out-of-focus exposures.) The center of the dim-frames histogram resulting from this data set, and the center of the dark-frames histogram, serve as two points that define a line, with no curve fitting required. The center of the dark-frames histogram serves as the offset value, and the slope of the line serves as the gain value.

Still other embodiments do not collect dim grey image frames at different discrete exposure conditions. Rather, an unfocused camera is waved in front of a white wall for an interval under dim grey illumination conditions, viewing it from different distances and angles, while collecting a thousand or more image frames. Due to the variety of different poses with which the camera views the wall, the wall will appear lighter or darker in different of the images (but uncolored). Each image frame is again divided into 8×8 groupings, and an abscissa value is computed for each grouping. A set of data is thereby collected for each pixel, relating its raw output value to its associated abscissa value for a thousand or so frames. Again, a curve can be fit to such data set, relating different abscissa values to different pixel values, e.g., again yielding gain and offset values for the pixel under dim grey illumination conditions.

While no “center point” value, per se, is determined in the just-described implementation, the effect is the same as in the earlier-described implementation. That is, we characterize a pixel's statistically-typical (mid-point) raw output value from non-colored (grey) light as a function of different dim illumination levels.

To review, the operations in this particular embodiment serve to characterize, for each pixel and for one or more dim illumination conditions (i.e., abscissa value(s)), its offset value (i.e., its parametrically-estimated center-point value under dark conditions) and its gain (the slope of the best-fit curve, indicating the rate at which the center point rises with rises in illumination, which in simple implementations is treated as invariant across dim illumination conditions). We term this GGO data, for Grey Gain and Offset. For the illustrative IMX477 sensor, the grey gain values for green pixels may be on the order of 1.3; the gain values for red pixels may be on the order of 0.7; and the grey gain values for blue pixels may be on the order of 0.65. The color dependence is a consequence of the quantum efficiency of silicon at the different wavelengths, and the differences in areas under the respective green, red and blue filter curves. Sensor-wide, the gains average to 1.0 in this particular embodiment. The offset values (center point values) will be around 256 (for the case of the IMX477 sensor). There will be pixel-to-pixel variations in gain and offset values, even between pixels of the same color that adjoin or neighbor each other in the Bayer array.

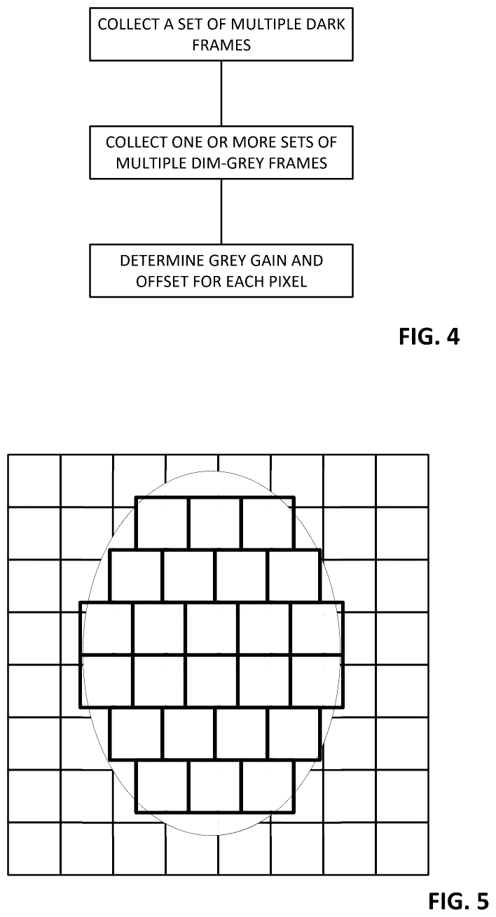

The foregoing operations are summarized in the flow chart of FIG. 4.

As noted above, a noise value for each pixel can be determined from each of the earlier-detailed histograms, e.g., the histograms determined from the set of dark-state image frames and from the one or more sets of dim-illumination image frames. In some embodiments, five or more noise values for a pixel may be determined, e.g., from the set of dark-state frames and from the four sets of dim-illumination frames. Such multiple noise values for a single pixel determined under different illumination conditions will often be similar, but sometimes not. This noise value associated with a pixel indicates, in a fashion, the trustworthiness of its output data.

In some embodiments, this pixel trustworthiness metric is employed in computing the local brightness metric, e.g., the sum of pixel values in the abscissa group. For example, each pixel's contribution to the sum can be inversely-weighted with the pixel's noise metric. In one particular implementation, the pixel in an abscissa block having the lowest noise value serves as a reference pixel, and contributes to the abscissa sum with a weight of 1.0. The value of each other pixel is weighted by a factor of less than 1.0 in computing the abscissa sum, with the weighting being the ratio of the reference pixel noise value to the subject pixel's noise value. So-doing diminishes the final value of the abscissa value, so a reciprocal gain factor can be applied to the weighted pixel sum, so the abscissa values of all blocks across the sensor are comparable.

Where several noise values are computed for a pixel, from different histograms, a single noise value can be reached by averaging the values, or taking the maximum of the different values, or using the noise value derived from a specified one of the histograms-such as the noise value derived from the dark-frames histogram.

### Pixel Byte Codes

Characterization information about a sensor's pixels, e.g., of the sort detailed above, is desirably stored in a standardized, compact, format, so as to facilitate use of such data by other systems. One example is an image processing program that performs a ShadowChrome operation, of the sort detailed below, on raw captured pixel data received from an image sensor.

Consider, as an example, the noise value for a pixel, determined as in the foregoing paragraphs. Excepting noise values that indicate serious pixel flaws (discussed below), the range of noise values determined for a particular instance of the IMX477 sensor may range from 1.036 digital numbers to 3.142 digital numbers. Each of the numbers is a real, as opposed to an integer, value, and so normally would take more than one 8-bit byte to represent.

To effect a compact representation of such data, applicant employs a bin mapping arrangement. For example, applicant uses an 8-bit byte to identify 255 value bins, here termed bin 0 to bin 254. The span of pixel noise values to be expressed (1.036 to 3.142, in the case of one particular sensor) is divided into 255 equal-size ranges. Here the span is 3.142-1.036, or 2.106, and when divided into 255 equal ranges yields range sizes of 2.106/255, or 0.008259. Each successive bin corresponds to a successive segment of the span (2.106, incrementing from the low value of 1.036, in steps of 0.008259). That is, the bins correspond to noise values as follows:
Bin 0 1.036 to 1.044259
Bin 1 1.044259 to 1.052518
Bin 2 1.052518 to 1.060776
Bin 253 3.125482 to 3.133741
Bin 254 3.133741 to 3.142.

By this arrangement, every possible real-valued noise datum between 1.036 and 3.142 falls within one of these 255 bins, and can thus be represented by the integer index number of the corresponding bin (0-255), instead of the by the real-valued noise datum. Thus, if a pixel has a noise value of 1.051111, it is compactly represented by the bin index value “2,” or 00000010 in binary. All noise values can similarly be compactly represented by just eight bits. The “loss” of such a compression system is inconsequential in this application.

Data storing the definition of bins particular to a given sensor can be stored in memory, e.g., on the sensor, and can be transferred with the 8-bit index values (pixel byte code data), to allow resolution of these 8-bit values into corresponding noise values (e.g., the middle of each bin's noise range).

The just-described arrangement uses bins of fixed increment size. Relatively few pixels will have noise values represented by very low and very high bin numbers; most pixels will have noise values falling in a mid-range of bins.

In another arrangement, the bins are of various increment (range) sizes, chosen so that each bin represents about the same number of pixels. In the case of the IMX477 sensor, its pixels' 12M noise values can be sorted by order. The sorted list can then be divided into 255 successive ranges of equal pixel-counts. The middle of each range indicates the mid-point of noise values represented by a given bin.

To illustrate, 12M pixels divided by 255 is about 48K pixels. The index 0 (indicating bin 0) serves to represent those pixels whose noise values fall within the 48K lowest noise values of all pixels on the sensor. The index 1 serves to represent those pixels whose noise values fall within the next-lowest 48K noise values of all pixels on the sensor. And so forth until the index 254 serves to represent those pixels whose noise values fall within the topmost 48K noise values of all pixels on the sensor.

Each bin can be associated with the noise value in the center of the range it covers (i.e., bin 0 is associated with the median noise value of the 48K smallest noise values in the sorted list; bin 1 is associated with the median noise value of the noise values ranked 48K to 96K in the sorted list, and so on). These 255 median noise values are stored as a list in a memory associated with the sensor. To effect compression, the noise value of a given pixel is compared against the list of 255 median values, to determine which median value is the closest. The index of that bin is then stored to represent the noise value of that pixel.

Still another byte code compression arrangement employs an 8-bit signed-integer representation, which expresses a value between −127 and +127. The value 0 is set to correspond to the sensor-wide average of pixel noise values, which may be 2.1 for a given sensor. The value 20 is set to correspond to a noise value 0.2 digital numbers above the sensor-wide average. Values of 1-19 correspond to noise values linearly-spaced between zero and 0.2 digital numbers above the sensor-wide average (i.e., 2.1 to 2.3). The value 40 is set to correspond to a noise value 0.4 digital numbers above the sensor-wide average (e.g., representing a noise value of 2.5). And so on to the end of the positive range. Similarly with negative numbers. The value −20 is set to correspond to a pixel noise value 0.2 digital numbers below the sensor-wide average (i.e., 1.9); the value −40 is set to correspond to a noise value 0.4 digital numbers below the sensor-wide average (i.e., 1.7), and so forth. As with the foregoing arrangement, this arrangement allows the floating-point noise value of each pixel to be approximated with an 8-bit value. (It will be understood that the particular parameters of this arrangement will be selected in accordance with the range of noise values to be represented.)

In some embodiments, one of the integer values in the compressed alphabet (e.g., the index value 255) is reserved to indicate pixels that are deemed wholly-untrustworthy, e.g., dead pixels or pixels whose noise values are above a threshold and thus deemed to be worthless. In the particular case of computing abscissa values, such pixels' values can be wholly-disregarded. (A reciprocal gain factor can be applied to an abscissa calculation that includes such pixel, e.g., multiplying a sum of pixel values by 64/63 if one pixel in an abscissa group is flagged as wholly-untrustworthy and disregarded.)

While just-described in the context of noise values, all other characterization parameters for each pixel can similarly be represented as compressed byte codes. These parameters include the grey gain and offset value determined for each pixel.

In some embodiments, abscissa values are derived from captured imagery (e.g., by circuitry on the image sensor chip) and are transferred with the raw pixel data to a receiving system for processing. Such abscissa values are commonly real-valued (e.g., floating point data, not integer data), and so are also desirably represented as compressed byte codes.

In an exemplary embodiment, the byte code characterization data for sensor pixels is stored in memory on the sensor. When image data is transferred from the image sensor (e.g., 12M raw pixel values), the associated byte code characterization data for those pixels is also transferred, providing the receiving system a set of sensor metadata it can used to process (e.g., enhance) the raw imagery.

In other embodiments, the byte code characterization data for a sensor is stored remote from the photosensor, such as in memory distinct from the photosensor-either in the camera or apart from it, as in an online metadata repository.

This characterization data is a data overhead that at first seems large (multiple metadata bytes for each pixel). But such data is substantially invariant, so once transferred to a receiving system, it can be stored there and not transferred again. Instead, later sets of raw image data can be transferred alone, and make use of pixel byte code data earlier received by the processing system.

### End-Use of Characterization Data

After characterization data for a camera has been gathered and stored, a user employs the camera in an imaging session, capturing one or more frames of raw image data. This raw image data is then processed in accordance with the characterization data to generate transformed imagery with enhanced (refined) pixel values.

At dim lighting levels with a static scene, each pixel acts akin to a noise generator, outputting a pixel value that varies frame to frame. The statistically-expected center-point value of such noise-like variation is known as a function of local brightness (abscissa value) from the characterization phase, for the case of grey illumination. If, however, the pixel illumination is colored, the center point of such variation will diverge from its expected center value. For example, if the illumination falling on the pixel contains more red light than does uncolored (grey) light of comparable brightness, then the noise-like output values from a red-filtered pixel (a “red pixel”) will tend to be above the expected center-point value. If the illumination contains less red light than does uncolored light, then the output values from a red pixel will tend to be below the expected value for that level of local brightness.

Thus, to determine an enhanced value for a subject pixel, the associated abscissa value (local brightness) is first determined, e.g., by summing values in the 8×8 grouping of which the subject pixel is a part. (The abscissa variants noted earlier can be used here again, including weighting of pixel contributions based on stored pixel noise data, and computing the abscissa value from a group of pixels across multiple image frames.) Calibration data stored in association with the pixel (e.g., gain and offset values) are recalled from memory, and are used to compute an expected, statistically-typical, center point (mid-point) value for the pixel in grey illumination conditions having this abscissa value, e.g., by use of the polynomial equation determined for the pixel. This statistically-expected center point value for the pixel is then compared to the pixel's raw value. This may be done by subtracting the expected center point value from the pixel's raw value to yield a center point-adjusted pixel value, or pixel-variance value, near zero. (The expected center point value is typically a floating-point value, and the pixel's raw value is typically an integer value, so the pixel-variance value is typically a floating-point value near zero.)

If this comparison indicates the raw pixel value for a red pixel is above its statistically-expected center point value (i.e., the pixel-variance value is above zero), this indicates the pixel is likely illuminated with more red than is present in grey light of comparable brightness (i.e., more red than would be present in grey light having the same abscissa value). Green and/or blue light at the red pixel location is likely diminished relative to the grey light case, in order to yield the given local brightness metric. If the comparison indicates the raw pixel value is below its statistically-expected center point (i.e., the pixel-variance value is below zero), this indicates the pixel is likely illuminated with less red that is found in grey light of comparable brightness, and therefore green and/or blue illumination at the red pixel location is likely present at an intensity greater than the grey light case for that brightness.

The output of this comparison can be either: a binary datum (e.g., the raw pixel value is above/below its expected value, indicated by the pixel variance being above/below zero); a ternary datum (allowing for the rare case of the raw and expected values being equal, and the variance value thus equal to zero); or it can be multi-valued, such as a floating point datum indicating the sign and magnitude of difference between the raw and expected pixel values (i.e., the variance).

Mathematically, this comparison can involve transforming four variables into a floating-point variance value for a pixel, namely: (a) the pixel's raw value (Raw), (b) the local brightness metric (Abscissa), and the (c) Offset and (d) Gain values associated with that pixel from the characterization phase. In a particular embodiment:

$$Variance Value = Raw - ( Abscissa * Gain + Offset )$$

The term in parentheses provides an estimate of the pixel's statistically-expected center-point value in grey illumination conditions of a brightness indicated by the Abscissa value. The difference between this statistical center-point value, and the Raw integer pixel value, yields the variance value for that pixel, and makes the function statistically zero-mean for the case of grey illumination.

In dim illumination, deviation of a pixel's variance value from zero is never very large (i.e., the raw and expected values are similar). Unlike in well-illuminated imagery, a red pixel's variance value in dim imagery isn't going to vary by tens (or hundreds) of digital numbers in accordance with its redness. Rather, redness is discerned as a statistical proclivity for a red-filtered pixel's variance value to be above zero more frequently than below (i.e., a proclivity for a red pixel's raw integer value to be above its estimated center point value more frequently than below).

Such a statistical proclivity is more accurately discerned using more than a single data point. The spatial and temporal coherence of image data provides other usable data points, e.g., data from nearby red-filtered pixels. Spatial and temporal coherence refers to the fact that the chrominance and luminance (“color” for short) at an image pixel is highly correlated to the color at spatially-proximate and temporally-proximate image pixels (in the case of a series of images, as in video).

For example, to better judge the redness of illumination at a subject red pixel, the four nearest red pixels in the image frame may also be considered, i.e., the red pixels located two rows above (to the north direction), two rows below (to the south direction), two columns left (to the west direction), and two columns right (to the east direction), of the subject pixel. For each, the above-described comparison with its corresponding statistical center point value is performed, e.g., yielding comparison data, such as a variance value. The comparison data for the subject red pixel can be combined with comparison data for each of these four neighboring red pixels to yield an aggregate result. For example, the variance value for the subject red pixel can be averaged (or simply summed) with the variance values for each of these four neighboring red pixels to yield a group value. We sometimes term this value the “zero-mean” group or aggregate variance value since, in grey illumination, it has a statistical zero mean. The zero-mean group variance value from this five-pixel group indicates the relative redness of light on the subject pixel. The greater the value, the greater the redness of the subject pixel, and the more negative the value, the lesser its redness.

In a simple embodiment, we consider only the binary result of each such comparison. That is, we disregard the magnitude of the five pixel variance values in the group, and consider only their signs. If a variance value's sign is negative, we regard it as a vote-against red; if the sign is positive, we regard it as a vote-for red. In a five pixel group, the aggregate vote can thus result in six different outcomes, namely: a net vote of 5-against red, 3-against, 1-against, 1-for, 3-for, or 5 for red. These states may be represented as aggregate variance sign totals of −5, −3, −1, 1, 3 or 5. (The term aggregate variance total is used for both the case of summed or average multi-valued variance values, and for aggregate binary votes, e.g., based on signs of the variance values.) Each of the six detailed different outcomes can be mapped to a corresponding enhanced output value for the subject red pixel.

The range of enhanced output values for the red pixel can start, at the low end, at zero, i.e., no red. At the high end, the maximum enhanced output value for the red pixel will depend on local brightness (e.g., the abscissa value). That is, in a dim scene, e.g., with 8-bit raw pixel values peaking at five digital numbers above dark state values, there will be no bright, stoplight-red pixels having bias-compensated values up around 200. In this circumstance, the six different outcomes may be respectively mapped to a range of 0-5 digital numbers for enhanced (refined) pixel output values. A table stored in memory may be used, e.g.,

TABLE I

| Aggregate Variance Total | Enhanced Pixel Value |
|---|---|
| −5 | 0 |
| −3 | 1 |
| −1 | 2 |
| 1 | 3 |
| 3 | 4 |
| 5 | 5 |

In other embodiments, mappings can be established otherwise, such as by a parametric equation or a trained neural network.

With greater local brightness, the upper end of the enhanced pixel values can be increased commensurately.

As indicated, proximity and its variants (which are regarded as synonymous with terms such as locality and neighboring) can be in frame time, as well as in pixel space. That is, just as spatially-neighboring pixels are correlated in attributes (e.g., luminance and chrominance) and provide information relevant to each other, so too with pixels that are temporally-neighboring. In a burst of image frames, or in video, a first pixel at a location in one frame has properties that are correlated with those of second pixels at corresponding locations in one or more preceding frames and/or following frames (and also to spatial neighbors of such second pixels).

In one such embodiment, a pixel's enhanced output value is determined by reference to a group of five pixels centered on the subject pixel in one frame (as in the example given above), and also to five pixels in each of two preceding and in each of two following frames, i.e., 25 pixels in all. In such case there are 26 different aggregate variance totals that might arise, i.e., −25, −23, −21 . . . 23, 25. Each of these values can be mapped to a different enhanced output pixel value in the range 0-5 (in the circumstance of an abscissa value indicating a very dark image excerpt). In such case, enhanced pixel values having granularity of less than one may be used, e.g.:

TABLE II

| Aggregate Variance Total | Enhanced Pixel Value |
|---|---|
| −25 | 0 |
| −23 | 0.2 |
| −21 | 0.4 |
| −19 | 0.6 |
| −17 | .8 |
| −15 | 1 |
| −13 | 1.2 |
| . . . | . . . |
| 21 | 4.6 |
| 23 | 4.8 |
| 25 | 5 |

Image pixels are typically integers. To represent the fractional values shown in Table II, the bit-depth used in representing the input imagery (e.g., N bits) can be expanded (e.g., to N+P bits) to represent the output, enhanced, imagery, so as to accommodate the increase in different pixel values that can be discerned with the present technology. That is, a system that receives raw input imagery in 8-bit form may output enhanced imagery in 10-, 12-bit or 14-bit form. Similarly, 10-bit input imagery can yield 12-, 14- or 16-bit enhanced output imagery. Commonly an expansion of bit depth, P, of 2 or 4 bits is used, although expansions of greater or fewer bits can be employed.

In other embodiments, a mapping table is not employed. Instead, the output, enhanced, pixel values are computed from the aggregate variance value for a pixel, and a local brightness metric. A particular example proceeds as follows: from each of the 64 pixels in the illustrative 8×8 abscissa block, the median dark-frame value for all pixels on the photosensor is subtracted. In the case of a sample IMX477 sensor, this may involve subtracting the integer 256 from each raw pixel value in the abscissa block (i.e., the bias-compensated raw pixel value). The 64 results are averaged, yielding a small floating point average brightness metric (e.g., having a value less than 50 digital numbers, instead of a value exceeding 250). In the subject abscissa block, the floating-point average brightness metric may be 8.55. Next, for each pixel in the abscissa block, its aggregate variance value is divided by the number of pixels in the group that contributed to that aggregate value. For example, if the aggregate variance value for a subject red pixel has a value of −2.33, based on the variance of that red pixel relative to its expected mid-point value, combined with the variances of the red pixels to the north, east, south and west relative to their respective center point values, then the group comprises five pixels, and the average variance value for the subject pixel is thus −2.33/5, or −0.47. This average variance for the subject pixel's group is then summed with the floating-point average brightness metric, or 8.55+(−0.47). This operation yields an enhanced output value of 8.08 for the subject red pixel.

Thus, one embodiment of the technology concerns processing data from a photosensor array that includes red-, green, and blue-filtered (colored) pixels. A relative brightness metric associated with a particular one of the pixels is derived based on values of red-, green- and blue-colored pixels in a first neighborhood of five or more pixels. (This neighborhood includes the particular pixel.) Calibration data earlier-sensed from this particular pixel is recalled from storage and is provided to an enhancement module. Also provided to the enhancement module are the brightness metric, an N-bit raw pixel value from said particular pixel, and N-bit raw pixel values from other pixels that are spatially- and/or temporally-proximate to said particular pixel. The enhancement module operates on this data and outputs, to a receiving system or application, an enhanced (N+P) bit pixel value for the particular pixel, where P>0. (The receiving system or application may then apply conventional image signal processing operations, such as white balancing, color demosaicing, etc., to the enhanced pixels—changed only insofar as the increased pixel bit-depth requires.)

In one particular example, the pixels that are spatially-proximate to the particular pixel are within 11 or 64 rows or columns of the particular pixel in the photosensor array. Of course, larger or smaller regions of pixels can also be used.

While such method can be applied to a single subject pixel, without similarly-processing nearby pixels, more typically such processing is applied to a dim region of plural contiguous pixels, including each of red, green and blue pixels.

In one particular implementation, the enhancement module compares the N-bit raw pixel value from the particular pixel with associated statistical center-point data determined from its stored calibration data, to generate a first binary comparison value (e.g., greater or less than), a trinary comparison value (e.g., greater, less than, or equal to), or a multi-valued comparison datum (e.g., a numeric difference value). Similarly, the module compares the N-bit raw pixel value from other spatially and/or temporally-proximate pixels with respectively-associated statistical center-point data determined from their stored calibration data, to generate additional comparison data. These first and additional comparison data are combined (e.g., by summing or averaging) to yield a result, which is then mapped to an N+P bit output pixel value for the particular pixel.

As explained earlier, the expected center-point datum for each pixel can be determined by inputting some or all of the calibration data for the pixel, together with an associated brightness metric, as variable data in a polynomial equation that yields the statistically-expected center-point value.

The increase in pixel bit-depth from N-bits to N+P bits commonly reflects an increase in signal-to-noise ratio. Consider a system that takes, as input, 8-bit raw pixel values and provides, as output, 12-bit enhanced pixel values. If the input 8-bit values have RMS noise values averaging 1.5 digital numbers, the output 12-bit pixel values may have average RMS noise values of the same magnitude, e.g., less than 2 digital numbers. But since a digital number in the output pixel format represents a quantity that is 16-times smaller than a digital number in the input pixel format, a significant improvement in signal-to-noise ratio is achieved.

In many embodiments, where raw input pixels have bit-depths of N bits, and enhanced output pixels have bit-depths of N+P bits, the signal to noise ratio improves by a factor greater than 2\hat{ }(P-2) or 2\hat{ }(P-1).

Described earlier was a method for determining the noise of a pixel for a given illumination level, by capturing multiple pixel signal samples at the given illumination level, and determining their RMS variation. An analogous process can be performed for captured imagery: capture a set of multiple image frames depicting a scene, with consistent illumination frame-to-frame. Compute the RMS variation of each pixel across the several frames, and then average these RMS variations to yield an average RMS error across all pixels. The ratio of the average pixel value (across all pixels, across all frames), to this average RMS pixel error, yields the signal-to-noise ratio for the set of images, which is then taken as the signal-to-noise ratio for each image.

The just-described process essentially takes a centroid of the multiple images comprising the set, and takes this to be a noise-free, true depiction of the scene. Deviation from this ideal is then the basis on which signal-to-noise ratio is determined. Another approach to quantifying image noise is to capture a single image of a known scene, such as a test chart having uniform patches of one or more colors (e.g., white, grey, red, green and/or blue), with a given illumination level. Since each patch has essentially uniform luminance and chrominance across its extent, any variation in pixel signal values captured from such a patch, by pixels having like-colored color filters, is error. The RMS variation among the red pixels imaging a patch is one error metric; the RMS variation among the green pixels imaging the patch is a second error metric; and the RMS variation among the blue pixels imaging the patch is a third error metric. Each of these metrics, and/or their combination (e.g., as a mean value), is a measure of image noise. A ratio the average pixel value across the imaged patch, to the average RMS variation among the red, green and/or blue pixels (“like-colored pixels”), is a measure of signal-to-noise ratio in depiction of the test chart captured by the image sensor, which in turn indicates the signal-to-noise ratio of other imagery captured by the sensor at that illumination level.

For expository convenience, this specification often focuses on neighboring pixels, and groups of pixels, in a spatial sense. However, it should be emphasized that such neighboring groupings also extend to the temporal sense (using corresponding pixels in preceding frames and/or following frames), and to the spatial-temporal sense (using pixels that are proximate in both space and time dimensions).

In some embodiments, the size of the pixel neighborhood used to generate aggregate variance values varies from scene to scene, and/or for regions within a single image scene, to include more or less pixels. The change can be in response to operator input, such as setting a user interface control. Additionally, or alternatively, the change can be in response to abscissa values.

For example, in scenes/regions with less brightness (lower abscissa values), the neighborhoods can be made larger, since the imagery will otherwise appear to be noisier (i.e., the noise component of each pixel value will be a larger fraction of its average output value). The neighborhood may expand, e.g., to span an area that is up to 11 pixel columns wide and 11 pixel rows tall, centered on the subject pixel. All red pixels within this area are taken into account in determining the aggregate variance value for the subject pixel. Conversely, in brighter scenes/regions, the neighborhoods can be made smaller, since the image will need less remediation. And, as noted, the neighborhood can include pixels from proximate image frames. The neighborhood may expand, e.g., to encompass pixels from up to 21 frames, such as the 10 preceding frames and the 10 following frames (if ten frame latency is acceptable), or from up to the preceding 20 frames.

Some embodiments include a virtual AggroDial variable that serves to dial-up or dial-down the neighborhood size, to increase or decrease the aggressiveness of image noise reduction. This variable can be controlled by operator input or can be controlled (inversely) by the abscissa value.

The detailed embodiments commonly equally-weight the variance of each pixel in the neighborhood group (from its respective expected center point value) in computing the aggregate variance value for the subject pixel, but this is not necessary. In other embodiments, pixels more remote in pixel space or frame time can be weighted-less than pixels nearer the subject pixel.

Typically, the group of pixels from which an aggregate variance value is determined will be from a neighborhood of regular shape, such as a square or circle centered on the subject pixel. However, this is not essential. In other embodiments, the neighborhood shape need not be regular, nor even pre-defined. For example, a face detection algorithm can be applied to a frame of image data to identify a pixel region that spatially-corresponds to a face. Neighborhoods of pixels within this region can be clipped to stop at the region boundary, so that pixels outside the region do not contribute to the aggregate variance value for a pixel that forms part of the detected face.

Likewise with determination of abscissa values. For example, an 8×8 pixel abscissa block that spans a facial boundary can be clipped to prevent the inclusion of pixels outside the face region in determining local brightness. The resulting abscissa value can then be proportionately increased to compensate for shortfall of included pixels from the usual sum of 64 pixel values. (If the abscissa value is the average of the raw pixel values in the block, rather than their sum, then the average can simply be computed from the smaller count of included pixels.) Alternatively, the 8×8 pixel abscissa blocks can be shifted from their usual tiling pattern across the image, so as to better correspond to the boundary of the facial pixel region. A simple example of this latter arrangement is shown in FIG. 5, with a facial outline shown as an oval, the usual tiling of 8×8 blocks shown by the thin lines, and a shifted pattern of abscissa blocks shown in bold lines. Still more elaborate arrangements can be employed, if circumstances warrant.

Just as faces may be treated differently from other regions of an imaged scene, so may other content objects. These can include content object components. For example, depictions of a person's eyes and forehead can be treated differently from each other, with pixels associated with one feature not being employed in determining abscissa values or group variance values of the other.

In some embodiments, abscissa blocks and pixel groupings are defined on a visual object-basis (as in the face detection example given above). The position of the object may move frame-to-frame (e.g., due to movement of the object in a static frame, or due to panning of the camera across a static scene). The direction and speed of object motion can be detected by motion estimation algorithms known from MPEG video compression. FFT techniques may be used. The abscissa blocks and pixel groupings can shift location from frame to frame correspondingly.

(Note that the pixel size of the abscissa grouping does not need to be the same in the characterization phase as in the end-use operation phase, e.g., if the brightness metric is reduced to a per-pixel value, as discussed earlier.)

In the above-detailed embodiments, the aggregate variance value is, e.g., (a) the sum, across each pixel in the group, of the difference between the pixel's raw value and its expected center point value (expected, that is, given the local brightness as indicated by the pixel's associated abscissa value), or (b) a count based on the signs of the just-defined differences.

In an alternative embodiment, each neighborhood pixel's variance value is applied to a sigmoid-like transformation function, yielding a transformed value. The aggregate variance value can then be the sum, across each pixel in the group, of these transformed values, or a counted vote based on signs of the transformed values. Both cases may be referenced as an aggregate transformed variance value.

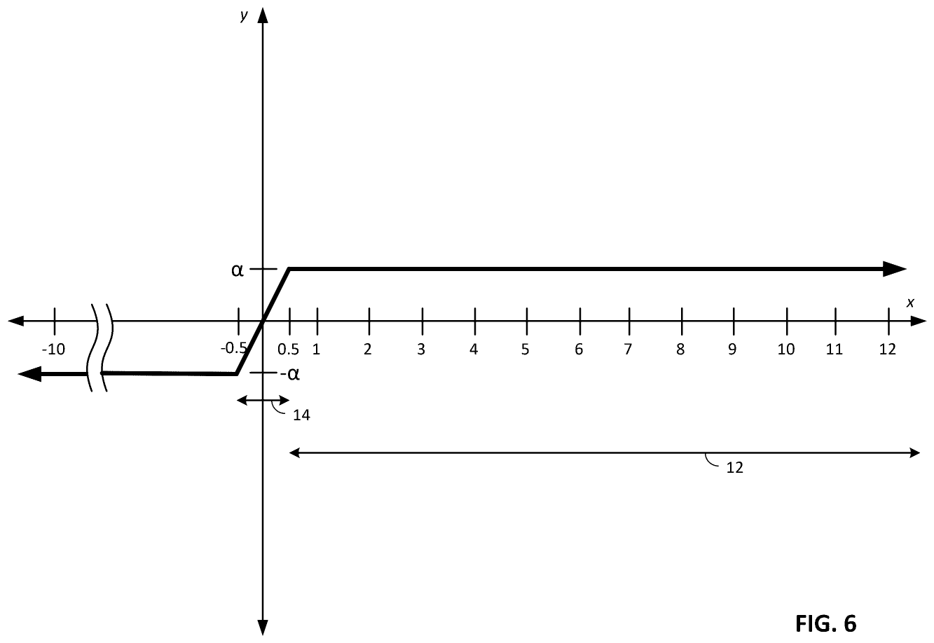

FIG. 6 illustrates a representative sigmoid-like transformation function. The values on the horizontal axis indicate the difference between a pixel's raw value and its expected center point value (i.e., its variance value). For differences greater than value 0.5 (range 12 in FIG. 6), the function returns the value α. In one implementation, α=1. For differences less than value −0.5, the function returns the value −α. For differences of intermediate values, i.e., between −0.5 and 0.5 (range 14 in FIG. 6), the function returns a value between −α and α. In the depicted example, the function has a constant slope in this range, returning twice the input variance value as the output value. Thus, a variance value of −0.4 returns a transformed value of −0.8α, and a variance value of 0.3 returns a transformed value of 0.6α. (In other implementations, non-constant slopes may be used in this range.)

This function acknowledges, in part, that raw pixel values are coarse, quantized metrics of incident illumination. A pixel value of 252, for example, may indicate a true red illumination having an intensity between 251.5 and 252.5. Thus, variance values of less than 0.5 may be due to quantization artifacts rather than indicating variations in illumination intensity. The FIG. 6 transformation function diminishes the weight given to such small variance values in computing the zero-mean group value.

This transformation function also diminishes the importance given to the magnitude of a variance value, and focuses on its sign instead (i.e., whether the difference is positive or negative). This is in acknowledgement that, in dim imagery, the distribution of pixel values around the expected center point values is very noisy. Statistical uncertainty dominates. Rather than perpetuate such noise, this and related embodiments disregard the magnitude of the difference value, and limit the information taken from the variance value for a pixel to simply its sign. Noise is thereby reduced in the resulting enhanced pixel value, while the lost information content is more than replaced by collecting information from neighboring pixels (i.e., other pixels in the group).

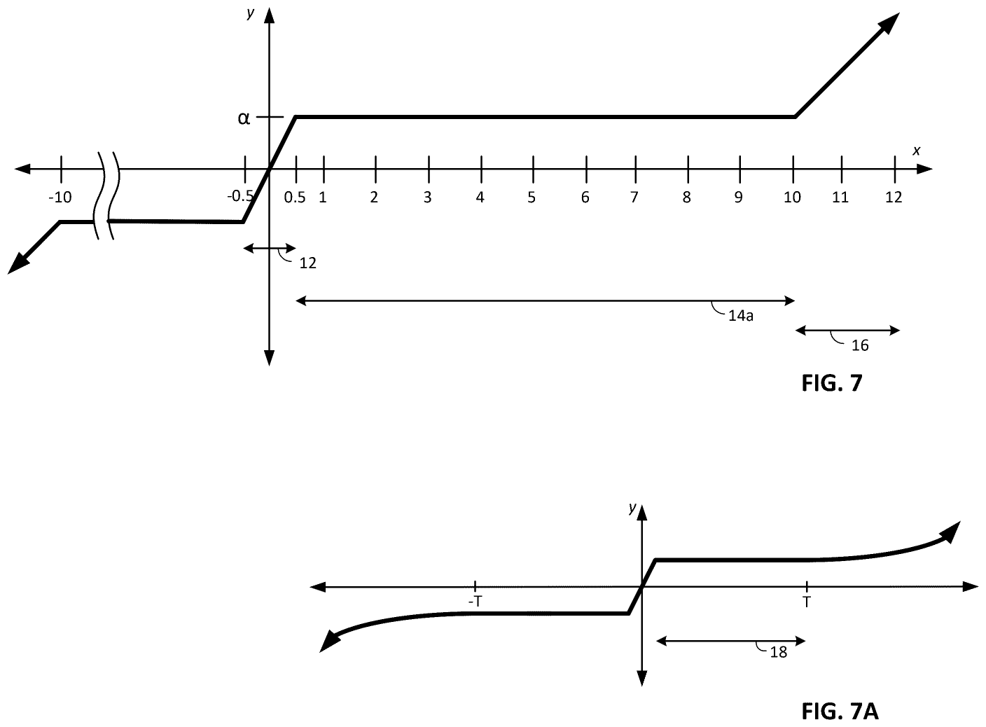

At some point, a pixel's variance value (i.e., its center point-adjusted pixel value) may become so large that its statistical uncertainty is small in comparison. To derive information represented by such large variance values, the transformation of FIG. 7 can be used instead. This function is like the earlier function over the indicated ranges 12 and 14a. However, above a threshold difference value (10 in this example), the output value increases beyond a. The transformed output value in this range 16 increases linearly by a (e.g., 1.0) for each unit of further increase in difference value. And symmetrically for negative difference values. (The threshold variance value, at which the output value begins increasing with increasing input value, can depend on the spread of the histogram for that pixel at that local brightness. A typical threshold has a value between one and four standard deviations of the dark frame histogram distribution, and more typically between 1.5 and 3.5. In the example of FIG. 7, the histogram has a standard deviation of 1.3, so a threshold value on the order of 2 to 5 might be used, instead of the illustrated threshold value of 10.)

The cost of using this function is greater complexity, with greater gate count for hardware implementation.

With still more complexity, the function of FIG. 7A can be used. Here the slope of the function is constant (here zero) over a range (18) of input variance values, but at a threshold T begins increasing-gradually at first, and then more rapidly, until it reaches a maximum slope (e.g., of 1.0). Such threshold T is commonly set to between 1 and 3 standard deviations of the dark frame histogram.

Again, a spatial- and/or temporal neighborhood is defined for each pixel-typically of an extent dependent on a brightness metric- and the sigmoid-like transform is applied to the variance value for each pixel in the neighborhood. The resulting transformed values are combined to yield an aggregate transformed variance value. This value is then mapped or otherwise transformed into an output enhanced pixel value.

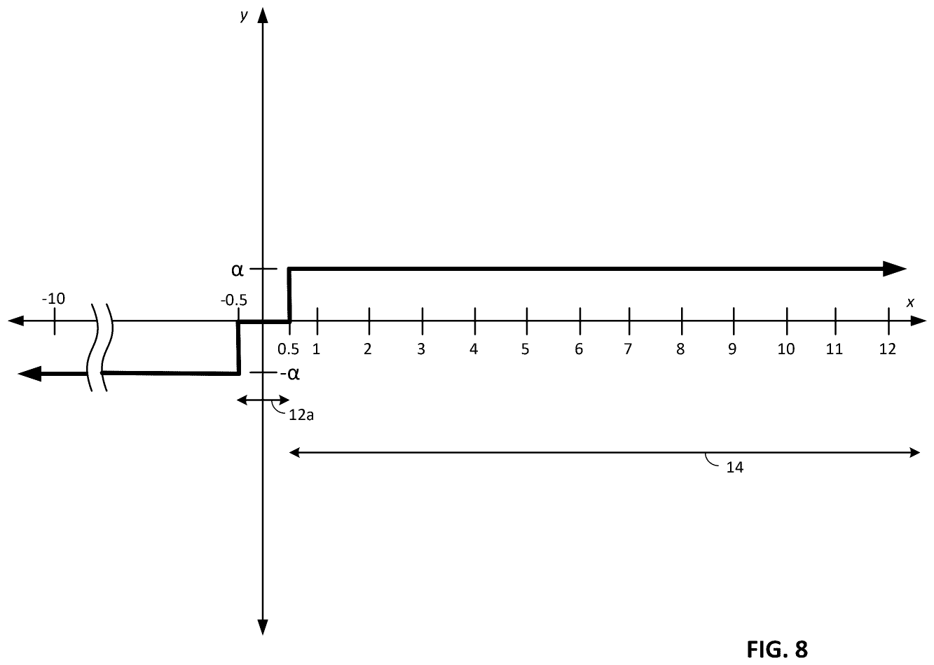

If simplicity of implementation is critical, the transformation function shown in FIG. 8 can be used. Here, pixel variance values between −0.5 and 0.5 are treated as having no information content, and so contribute nothing to the aggregate variance value. That is, in the range 12 of input variance values, the function output value is zero.

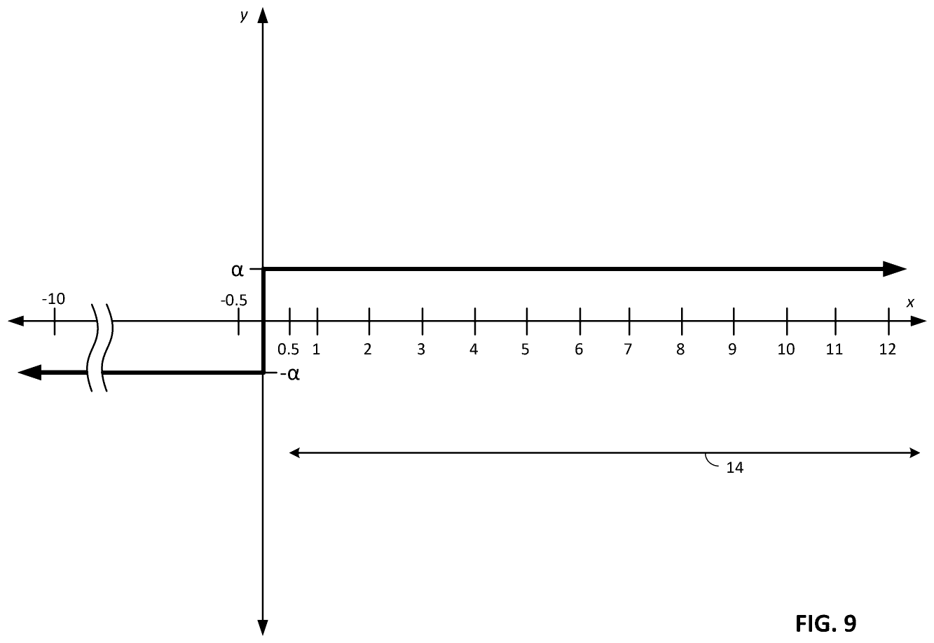

If still more simplicity is required, the function shown in FIG. 9 may be used. This function disregards the quantization uncertainty introduced by integer pixel values, and yields a transformed aggregate variance value that is simply proportional to the net count by which pixels in the neighborhood group having positive variance values exceed pixels in the group having negative variance values. This corresponds to an embodiment detailed earlier.

Many alternative transform functions will be apparent to the artisan. These are typically characterized by symmetry around the origin; small (or zero) output values for small input variance values and larger output values for larger input variance values; and a slope that varies across the range of input values (often with one or more discontinuities).

Referring back to the simple abscissa example of the 8×8 pixel abscissa block shown in 3, a critic may observe that brightness of pixel “B” is more highly correlated to that of pixel “A” than that of pixel “C”, yet “C” is included in the same brightness grouping as “B” while “A” is not. That's fair. The variety of different brightness groupings is nearly endless, and different groupings have different advantages.

An alternative strategy may define, for each pixel, an associated brightness grouping for which the subject pixel is at or near the center. The brightness metric may then be a weighted sum, in which pixels remote from the center are weighted less than pixels near the center. Etc., etc. The FIG. 3 arrangement, in contrast, has the advantage of simplicity, which reduces op-count (and gate count, if implemented in on-chip hardware). Each local brightness metric (abscissa value) is a simple integer sum, and each such value is used for all 64 pixels in the group.

Abscissa values can serve different purposes. One purpose is to serve as a coarse estimate of local luminance. If local luminance is above a threshold, it may not be necessary to apply any image enhancement.

A second purpose is to throttle the amount of image enhancement effort. Progressively more or less effort can be applied to combat image noise, in accordance with the brightness metric. This can include the above-discussed enlarging or shrinking the size of neighborhoods from which zero-mean group pixel values are determined.

A further purpose of the abscissa values is as the independent variable used to estimate the mid-point value expected from a pixel under given grey illumination conditions, e.g., per the formula given earlier.

Yet another purpose of the abscissa values is as a down-sampled representation of an image, on which, e.g., coarse motion estimation can be performed.

As discussed, the aggregate variance value associated with a pixel (or the aggregate transformed variance value, which is a species thereof) is indicative of the pixel's color, but on an unfamiliar scale (e.g., −25, −23, . . . , 25). Mapping of such values to enhanced output values can be established in various ways, such as by a table that linearly translates group values to enhanced pixel values in range extending from a low value of P to a high value of Q, where P is often zero, and Q depends on the local brightness.

The value Q can be established based on data from the corresponding abscissa block, such as scaled in accordance with the abscissa value, or based on the maximum raw or bias-compensated pixel value within the abscissa block. Or it can be based on such statistics grounded in a larger area of imagery, such as the abscissa block plus eight adjoining abscissa blocks. Or from the entire image frame. (The value P can be similarly-dependent.)

Alternatively, the values P and Q can be established (or adjusted from the above-determined values) by user interface controls, through which the user can make P and/or Q smaller or larger, or change the area of imagery from which the values of P and/or Q are programmatically-determined.

By automatic or manual adjustment of the values P and/or Q, the dim colors of captured imagery can be made brighter and brighter—as if increasing the scene illumination, in some cases unnaturally. For example, an image of paintings on a gallery wall of the Prado Museum, captured when the gallery is pitch black except for a single candle, may be increased in contrast until the image appears as if the paintings were illuminated by full daylight.

In other scenarios, the values P and Q can be established so as to keep the enhanced dim scene dark, but without all the noise that dark images typically include, e.g., by scaling the value Q to the largest bias-compensated pixel value in an abscissa block or larger area (which may be content-dependent).

In some situations, an image may include dim regions, but also well-lit regions. (The latter may be those regions having average raw pixel values more than 10 or 20 digital numbers larger than the corresponding dark frame raw pixel values.) In such case, the above-detailed ShadowChrome technology is applied to the dim regions, but not to the well-lit regions. (The well-lit regions do not suffer image noise like the dim regions, so ShadowChrome enhancement is not necessary). In such case, the value Q is chosen to provide a smooth tone-mapping transition between those regions where ShadowChrome is applied, and where it is not.

In other embodiments, mappings between aggregate variance values and enhanced output pixel values can be machine-learned. For example, synthetic dim training imagery can be generated from conventionally-exposed scenes or color test-charts, by reducing the bright pixel values by a factor (e.g., 10 or 100) to put the pixel values in a dim range, and then add noise having statistics like that measured in the calibration phase. (Increasing the bit resolution may be used to represent otherwise fractional dim pixel values.) The “true” color value for each pixel is known from the original bright scene, in conjunction with the applied brightness-reduction factor. A system can then learn the mappings from the aggregate variance values derived from such synthetic imagery and their “true” color values. This trained system can then perform the mapping of aggregate variance values to enhanced output pixel values.

Different mappings, between aggregate variance values and enhanced output pixel values, can be established for each differently-colored pixel type (e.g., red, green and blue in the Bayer case).

A different embodiment does not compute a floating-point statistically-expected center-point value for each pixel at different illumination levels. Instead, integer values are used for the pixel center point values, which can be determined by sorting the, e.g., 250 pixel values captured at each of five calibration illumination levels, and choosing the value of the middle pixel in the sorted list as the center value. Some noise reduction is lost, but computational simplicity is gained.

As earlier noted, the abscissa values from the calibration phase (e.g., a sum of 64 pixel values) may be made abscissa block-size independent, e.g., by dividing such sum by the number of pixels in the block (e.g., 64), yielding a per-pixel, brightness metric. The Grey Gain factor can then be expressed as a function of this per-pixel metric. So-doing facilitates use of variable abscissa block sizes in the end-use phase of operation. That is, in this second phase of operation, the size of the abscissa group can be made to be variable, e.g., changeable in response to user input through a graphical user interface, or changeable automatically under programmatic control.

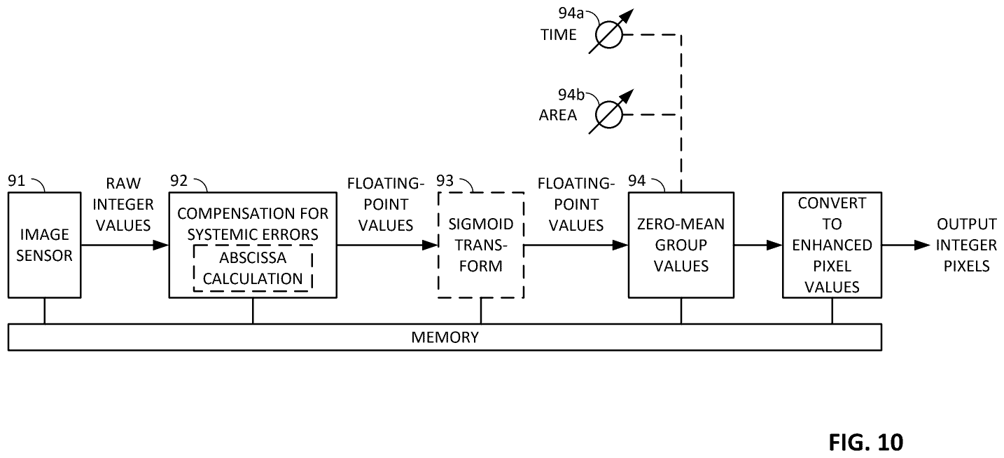

FIG. 10 illustrates one embodiment drawn from the foregoing disclosure. Raw Bayer pixel values are provided by an image sensor 91 to software or hardware logic 92 that addresses systemic errors, such as pixel-to-pixel variation. Such functionality includes determining local brightness metrics (abscissa values), determining the expected center point value for each pixel given its respective local brightness metric, and determining the pixels' differences from their respective center point values, i.e., their variance values. These variance values may each be transformed using a sigmoid-like transform 93. The result from each pixel is then aggregated with results from neighboring pixels to yield an aggregate variance value, by software or logic 94. The relative extent of the neighborhood, in time and/or space, can be manually or automatically adjusted by controls 94a and 94b, e.g., in accordance with local brightness (i.e., AggroDial). The aggregate variance value for each pixel is then converted to a corresponding enhanced (noise-reduced) integer pixel value, as discussed. Data values from the previous calibration operation, and from each of the just-discussed functional units, are stored in a memory and recalled as needed.

To review, the concept of ‘raw data’ being the immediate integer digital numbers (DNS) output from analog-to-digital conversion device(s) on electronic image sensors is well established in the art, along with the requirement to calibrate and/or correct such data. Concepts such as fixed pattern noise (FPN) mitigation and photo-response-non-uniformity (PRNU) mitigation likewise are familiar aims within modern digital imaging cameras. The nominal bit-resolution of a sensor has thus been defined by the A/D convertors, e.g. 8 bits per pixel, 10 bits, 12 bits, 16 bits, etc. The property of color measurement has of course been added by the Bayer (RGB) approach to manufacturing sensors, and many Bayer-like variants.

Together, both single frame instances otherwise known as still frames, and datacube instances whereby multiple image frames are collected as a video sequence in time, stretch the definition of the bits-per-pixel well beyond the coarse values defined by the A/D convertors themselves. The collective ‘sets’ of data, generally in well-defined pixel neighborhoods, create a kind of floating-point version of bits-per-pixel that become more responsive to pixel-DN-value histograms than they do to the classic FPN and PRNU. Once color channels are thrown into the mix, a clear distinction can be made between data corrections which address luminance and brightness within scenes, and the color imbalances caused by the different types of pixels when gray objects begin to exhibit various color directions as manifested by color pixel ratios. Brightness estimation on otherwise very noisy data emerges as a difficult problem to solve. And otherwise subtle relationships between pixels not well captured by the FPN/PRNU formalism manifest themselves.

The detailed arrangements measure, store and use new types of pixel-characteristic behaviors in universal ways that apply to different approaches to, e.g., the design of CMOS pixel architectures and their read-out structures. Pixel-byte-codes as described herein can perform this standardization across wide swaths of pixel types. Pixel-byte-codes assign single byte (8-bit) values to an evolving family of pixel behaviors which can be utilized by both classic non-linear image processing approaches as well as the more preferred neural-net form of image processing, where pixel-byte-codes become direct data participants within so-called feature vectors. All of this internal structure can be employed in a module which has nominal N-bit mosaiced data streaming as an input, and then dynamic range-extended N+P-bit data streaming as output. P is typically 2 to 3 for still image processing, and 3 to 6 for datacube processing having 2 through 64 or higher frame-instances in time. Low-light imaging capability is palpably improved, as is contrast enhancement in low-contrast scenes. Measuring skin tone nuances and accuracy is but one small example of a practical outcome of the disclosed technology.

### Concluding Remarks

It bears repeating that the present disclosure should be read in the context of applicant's preceding filings, U.S. application Ser. No. 18/056,704 and international application PCT/US23/73352. Applicant expressly teaches that the presently-detailed arrangements can be practiced using the technologies detailed in those applications, and vice-versa. By way of example and not limitation, the presently-detailed arrangements can be practiced using photosensors including the color filter arrays described in those previous applications.

Having described and illustrated the principles of the technology with reference to illustrative embodiments, it should be recognized that the invention is not so limited.

For example, while the specification focuses on imagery captured using image sensors employing Bayer pattern color filters, it will be understood that the detailed technology can be employed with image sensors employing different color filters, or no color filters (i.e., monochrome sensors).

While the detailed embodiments generally generate zero-mean pixel variance values, this is not necessary. For example, comparison with statistically-expected mid-point pixel values can be conducted without first subtracting a pixel's offset value.

In some embodiments, the abscissa groups do not span 2D pixel areas, but rather are structured as 1D pixel areas, such as excerpts from an image row or column. Such a group may comprise, e.g., three pixels to the left of the subject pixel and three pixels to the right of the subject pixel, in a row. In a limiting case, the group may comprise a single pixel on either side of the subject pixel.

In this and other embodiments, the abscissa group may include only pixels having the same filter color as the subject pixel so that, e.g., an abscissa group for a red-filtered pixel consists only of red-filtered pixels.

Although abscissa groups typically include the subject pixel, this is not essential; the subject pixel may be omitted. In an 8×8 abscissa block as previously detailed, for example, the abscissa value can be the sum of 63 pixels, omitting the subject pixel. If the subject pixel is red-filtered, and the abscissa calculation is limited to pixels of like-filter-color, then the abscissa value can be based on the values of the 15 other red-filtered pixels in the 8×8 group. In the case of a row- or column-excerpt abscissa group, the abscissa value for a red-filtered pixel may be based just on the value of the two nearest red-filtered pixels (e.g., the red pixel located two pixels to the right, and the red pixel located two pixels to the left, in a Bayer pattern), and can omit the subject pixel. The sum of these two pixels is the abscissa value in one particular example.

While the earlier-described ShadowChrome embodiments determine a statistically-expected mid-point value for a pixel in achromatic illumination, given the abscissa value, this is not essential. One exemplary alternative works as follows: each pixel in captured imagery is bias-compensated to remove its dark frame value, yielding pixel values for use in the calculations that follow. For each pixel, an abscissa value associated with that pixel is determined, typically employing the value of like-colored pixels in an abscissa group. This abscissa value ‘A’ may be normalized to a “per-pixel” value, such as by dividing a sum of pixel values in the abscissa group by the count of pixels in the abscissa group. A gain non-uniformity value ‘g’ for the pixel (earlier determined, e.g., in the ChromaBath stage of processing) is recalled from memory, and expresses the disparity between that pixel's gain and the average gain of like-colored pixels within a local neighborhood (e.g., 8×8 or 16×16 pixels) encompassing the subject pixel. An exemplary pixel may have a gain non-uniformity value g, e.g., of −0.04, indicating its bias-compensated output level is 96% that of the average bias-compensated output levels of other like-colored pixels in the neighborhood, for a given illumination. The value of the subject pixel is then adjusted by an amount depending on its gain disparity value g and its associated abscissa value A. For instance, if a subject red pixel Pj is in a row-wise sequence of red pixels Pᵢ, Pⱼ and Pₖ, and the abscissa value A is based on Pᵢ and Pₖ), the enhanced output value for the subject pixel Pⱼ is the value of Pⱼ plus the product of the gain g and the abscissa value A. That is:

P_{j-enhanced}=Pⱼ+(gA)

As before, such processing can yield non-integer values for the enhanced pixel values, so greater output pixel bit-depths (N+P bits) are desirably used to represent this additional information.

Implementation of the detailed embodiments will commonly involve considerations of image edge/border issues, as occurs frequently in image processing. For expository clarity, these issues are not addressed.

It will be appreciated that data produced from an image sensor photoreceptor is processed in myriad ways, from an analog charge of photoelectrons collected in a photocell, to amplification and conversion of such charge into digital form, to various manipulations that are successively applied to the digital data. All such information is here regarded as pixel values, or pixel signals.

The reader is presumed to be familiar with image sensors and color filter arrays generally. The text “Image Sensors and Signal Processing for Digital Still Cameras” by Nakamura, CRC Press, ISBN 978-0-8493-3545-7, 2005, is a treatise on the topic. A good foundation is provided by the original Bayer patent, assigned to Kodak, U.S. Pat. No. 3,971,065. Patent documents US20070230774 (Sony), U.S. Pat. No. 8,314,866 (Omnivision), US20150185380 (Samsung) and US20150116554 (Fujifilm) illustrate various color filter arrays and image sensor arrangements-details of which can be incorporated into embodiments of the technology (including, e.g., pixels of varying areas, triangular pixels, cells of non-square shapes, etc.). Use of interference filters in color filter arrays are detailed, e.g., in U.S. patent publications 20220244104, 20170195586, 20050153219 and 6,638,668.

It should be recognized that neural networks can be employed in embodiments of the technology. In one such arrangement, a neural network is used to determine a brightness metric associated with a given pixel. For example, a neural network can be trained to select an abscissa grouping of pixels that will serve as a superior basis for determining expected mid-point values for pixels based on stored characterization data. This can be done by training with different candidate group selections and evaluating results to maximize a figure of merit that depends on results achieved by the different alternatives. The manner in which values of the selected group of pixels are to be used in producing a brightness metric can similarly be determined by a training exercise, e.g., by trying different forms of combinations and weightings to find one that maximizes a figure of merit.

Other embodiments employ a neural network to produce enhanced N+P bit pixel values from an array of binary, trinary or multi-valued data expressing how the value of each captured pixel compares to an expected mid-point value for that pixel, given local image brightness.

Still other embodiments abandon the sequential method of combining pixel values from fixed groups of abscissa pixels in a parametric manner to yield brightness metrics, computing expected mid-point values for pixels based on corresponding brightness metrics, and deriving enhanced N+P bit pixel data based on comparisons of expected versus actual pixel data. Instead, a neural network can take as inputs (1) pixel data for a region of imagery (e.g., 128×128 pixels), and (2) previously-determined characterization data for those pixels, and can output corresponding enhanced pixel data. Such a network can be trained using reference imagery of known luminance and chrominance (e.g., test chart data, or the CAVE dataset identified in patent application Ser. No. 18/056,704), from which a large corpus of training imagery is synthesized (e.g., by degrading the images in known ways, such as diminishing luminance and/or contrast, and adding noise). Ground-truth about the proper N+P bit pixel data corresponding to each training image is determined from the known original content of the training imagery, and the known degradation operations. Parameters and/or weights of the network are then adjusted (e.g., using stochastic reverse gradient descent training methods) to establish values that cause the network to convert the stated inputs to the desired N+P bit output imagery.

In a specific embodiment, the information input to the neural network takes the form of (a) raw pixel data for a region of imagery, and (b) pixel byte code data associated with each pixel of the sensor. This latter input serves as a compact “feature vector” that can embody information such as grey gain, offset, pixel noise, and/or associated abscissa value, for each pixel.

Neural networks can be implemented in various fashions. Exemplary networks include AlexNet, VGG16, and GoogleNet (U.S. Pat. No. 9,715,642). Suitable implementations are available from github repositories and from cloud processing providers such as Google, Microsoft (Azure) and Amazon (AWS).

The processes and arrangements disclosed in this specification can be implemented as instructions for computing devices, including general purpose processor instructions for a variety of programmable processors, such as microprocessors (e.g., the Intel Atom, the ARM A8, etc.) These instructions can be implemented as software, firmware, etc. These instructions can also be implemented in various forms of processor circuitry, including programmable logic devices and field programmable gate arrays.

Implementation can additionally, or alternatively, employ dedicated electronic circuitry that has been custom-designed and manufactured to perform some or all of the component acts, such as an application specific integrated circuit (ASIC), or as an array of hardware logic gates integrated on the same semiconductor as the image sensor.

Software instructions for implementing the detailed functionality can be authored by artisans without undue experimentation from the descriptions provided herein, e.g., written in C, C++, Visual Basic, Java, Python, Tcl, Perl, Scheme, Ruby, Matlab, etc., in conjunction with associated data.

Software and hardware configuration data/instructions are commonly stored as instructions in one or more data structures conveyed by tangible media, such as magnetic or optical discs, memory cards, volatile and non-volatile semiconductor memory, etc.

This specification has discussed various embodiments. It should be understood that the methods, elements and concepts detailed in connection with one embodiment can be combined with the methods, elements and concepts detailed in connection with other embodiments. While some such arrangements have been particularly described, many have not-due to the number of permutations and combinations. Applicant similarly recognizes and intends that the methods, elements and concepts of this specification can be combined, substituted and interchanged—not just among and between themselves, but also with those known from the cited art. Moreover, it will be recognized that the detailed technology can be included with other technologies-current and upcoming—to advantageous effect. Implementation of such combinations is straightforward to the artisan from the teachings provided in this disclosure.

While this disclosure has detailed particular orderings of acts and particular combinations of elements, it will be recognized that other contemplated methods may re-order acts (possibly omitting some and adding others), and other contemplated combinations may omit some elements and add others, etc.

Although disclosed as complete systems, sub-combinations of the detailed arrangements are also separately contemplated (e.g., omitting various of the features of a complete system).

While certain aspects of the technology have been described by reference to illustrative methods, it will be recognized that apparatuses configured to perform the acts of such methods are also contemplated as part of applicant's inventive work. Likewise, tangible computer readable media containing instructions for configuring a processor or other programmable system to perform such methods is also expressly contemplated.

To provide a comprehensive disclosure, while complying with the Patent Act's requirement of conciseness, applicant incorporates-by-reference each of the documents referenced herein. (Such materials are incorporated in their entireties, even if cited above in connection with specific of their teachings.) These references disclose technologies and teachings that applicant intends be incorporated into the arrangements detailed herein, and into which the technologies and teachings presently-detailed be incorporated.

Appended to priority application 63/621,986 are two documents, entitled “ShadowChrome Appendix” and “ShadowChrome Tutorial,” which elaborate certain points and delve into further aspects of the technology. These documents form part of the present disclosure.

In view of the wide variety of embodiments to which the principles and features discussed above can be applied, it should be apparent that the detailed embodiments are illustrative only, and should not be taken as limiting the scope of the invention.

1-16. (canceled)

17. A method comprising the acts:
exposing at least first and second different pixels in an image sensor multiple times in a first exposure condition, yielding a set of multiple first integer pixel values for each of said pixels;
from the set of multiple first integer pixel values for each of said pixels, discerning a first center point value for each of said pixels, the first center point value for the first pixel being different than the first center point value for the second pixel;
exposing at least said first and second different pixels multiple times in a second exposure condition brighter than the first exposure condition, yielding a set of multiple second integer pixel values for each of said pixels;
from the set of multiple second integer pixel values for each of said pixels, discerning a second center point value for each of said pixels, the second center point value for the first pixel being different than the second center point value for the second pixel;
determining, from the first and second center point values for each of said pixels, functions for respectively estimating center point values for each of said pixels at exposure conditions different than said first and second exposure conditions, and storing data characterizing said functions for later use.

18. The method of claim 17 in which a first center point value for one of said pixels is a non-integer value.

19. The method of claim 17 in which an average of said second center point values for said pixels is less than ten digital numbers, or less than three digital numbers, greater than an average of said first center point values for said pixels.

20. The method of claim 17 in which said determining comprises determining a gain and an offset value for each of said pixels, thereby characterizing a linear function for estimating said center point values at exposure conditions different than the first and second exposure conditions.

21. The method of claim 17 in which said first and second exposure conditions include illuminating the image sensor with achromatic light, said image sensor including filters of different colors on different pixels.

22. The method of claim 17 that further includes the acts:
capturing from a scene, under a third exposure conditions different than said first and second exposure conditions, exposed pixel values for said at least first and second pixels;
estimating, from said determined functions, center point values for said at least first and second pixels at said third exposure condition;
for each of said at least first and second pixels, ascertaining whether the exposed pixel value for said pixel is greater than said estimated center point value for said pixel at the third exposure condition; and
from results of said ascertaining acts, generating a refined pixel value for the first pixel.

23. The method of claim 22 in which the refined value for the first pixel has a greater bit-depth than the exposed pixel value for said first pixel.

24-27. (canceled)

28. In a photosensor array having rows and columns of pixels, a method comprising the acts:
(A) receiving a frame of image data captured with said photosensor array;
(B) deriving a relative brightness metric associated with a particular pixel in said frame of image data, based on values of a set of pixels within a first neighborhood associated with said particular pixel, a majority of pixels in said pixel neighborhood being within 64 rows and columns of said particular pixel;
(C) recalling stored characterization data associated with said particular pixel;
(D) providing to an enhancement module: (a) said brightness metric, (b) said characterization data, (c) an N-bit pixel value from said particular pixel, and (d) N-bit pixel values from other pixels that are spatially- and/or temporally-proximate to said particular pixel, namely that said other pixels are within 11 rows and columns of said particular pixel in (i) within said frame, and/or (ii) within 20 other image frames that precede or follow said frame; and
(E) receiving from said enhancement module an enhanced N+P bit pixel value for said particular pixel, where P>0.

29. The method of claim 28 in which the enhancement module performs acts including:
comparing the N-bit pixel value from said particular pixel with associated statistical center-point data that is determined from the stored characterization data and the associated brightness metric, to generate a first comparison datum;
comparing the N-bit pixel value from each of said other spatially and/or temporally-proximate pixels with respectively-associated statistical center-point data that is determined from stored characterization data and brightness metrics, to generate additional comparison data;
combining said first and additional comparison data to yield a result; and
determining the N+P bit pixel value for said particular pixel based on said result.

30. The method of claim 28 that includes determining a statistical center-point datum for each of said particular and proximate pixels, by inputting characterization data for the pixel, and an associated brightness metric, as variable data in a polynomial equation that yields said center point datum.

31. The method of claim 28 in which N-bit data captured by the photosensor array for the particular pixel, when examined over twenty or more frames at a first illumination level within ten digital N-bit numbers of dark, has a first RMS noise level, and the enhanced N+P bit data for said particular pixel, when examined over said twenty or more image frames at said first illumination level, has a second RMS noise level, wherein the second RMS noise level is less than half the first RMS noise level.

32-33. (canceled)

34. A method including the acts:
receiving image data that depicts a scene, comprised of N-bit values of pixels;
determining, for each of plural pixels in a region of said image data, a statistically-expected mid-point value for the pixel, given a level of brightness of said region;
for each of said plural pixels, comparing an actual value of said pixel in said received image data with the statistically-expected mid-point value for said pixel; and
from results of said comparing acts, determining an enhanced N+P bit pixel value for at least a first of said pixels, where P>1.

35. The method of claim 34 wherein said statistically-expected mid-point values for the plural pixels include plural different non-integer values.
